(19) United States
(12) Patent Application Publication
(10) Pub. No.: US 2006/0039686 A1
(43) Pub. Date: Feb. 23, 2006

(54) Line-of-sight-based authentication apparatus and method

(75) Inventors: Byung seok Soh, Suwon-si (KR); Taesuh Park, Yongin--si (KR); Yoon Sang Kim, Yongin-si (KR); Sang-goog Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/206,076

(22) Filed: Aug. 18, 2005

(30) Foreign Application Priority Data
Aug. 23, 2004 (KR) 10-2004-0066398

(51) Int. Cl. G03B 29/00

(52) U.S. Cl. 396/18

(57) ABSTRACT

A line-of-sight-based authentication apparatus and method are provided. In the method, a first image is generated by photographing the eyes of a person using first lighting generated on the same axis as a photographing axis of a camera and a second image is generated by photographing the eyes of the person using second lighting generated on a different axis from the photographing axis. Eye movements are tracked based on the first image and the second image and a track of the eye movements is identified. Then, it is determined if the identified track is the same as a track previously stored for authentication purposes.

### BACKGROUND OF THE INVENTION

This application claims priority from Korean Patent Application No. 10-2004-0066398, filed on Aug. 23, 2004, in the Korean Intellectual Property Office, the disclosure of which is incorporated herein in its entirety by reference.

1. Field of the Invention

Apparatuses and methods consistent with the present invention relate to authentication of a user, and more particularly, to authentication of a user using eye movements.

2. Description of the Related Art

There are a variety of devices, such as house doors, entry doors of research centers or companies, safes, and automated teller machines (ATMs), that allow only authorized users to access or use them. Such devices use authenticators to authenticate authorized users through, for example, keys, passwords, or biological recognition.

Generally, key-based authenticators are used in doors. When a key-based authenticator is installed, a user always has to carry a key. If the user loses the key, an all-purpose key must be used. If the key is stolen, there is a danger of intrusion, i.e., unauthorized access.

In the case of password-based authenticators, users do not have to carry keys. However, when a user enters a password, the password can be inadvertently disclosed to others. For example, since traces of the password input by the user may remain on a password input plate, there is a risk that others will guess the password by combining several numbers or other characters having traces on the plate.

Biological recognition-based authenticators require users to register their biological information in advance, which is very inconvenient especially in the case of devices, such as ATMs, that are used by a great number of people.

### SUMMARY OF THE INVENTION

Exemplary embodiments of the present invention include an authentication apparatus and method using eye movements, which prevents fraudulent use of a code for authentication, assigns a user a unique code, and authenticates the user in a non-contact manner.

According to an aspect of the present invention, there is provided a line-of-sight-based authentication apparatus including a photographing unit which generates a first image by photographing the eyes of a person using first lighting generated on the same axis as a photographing axis of a camera and generating a second image by photographing the eyes of the person using second lighting generated on a different axis from the photographing axis; a track identifier which tracks eye movements based on the first image and the second image and identifies a track of the eye movements; and a matching determiner which determines if the track identified by the track identifier is the same as a track previously stored for authentication purposes.

According to another aspect of the present invention, there is provided a line-of-sight-based authentication method including generating a first image by photographing the eyes of a person using first lighting generated on the same axis as a photographing axis of a camera and generating a second image by photographing the eyes of the person using second lighting generated on a different axis from the photographing axis; tracking eye movements based on the first image and the second image and identifying a track of the eye movements; and determining if the identified track is the same as a track previously stored for authentication purposes.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a line-of-sight-based authentication apparatus according to an exemplary embodiment of the present invention;

FIG. 2 illustrates locations of a camera and infrared generators according to an exemplary embodiment of the present invention;

FIGS. 3A through 3C illustrate images of the eye taken using infrared rays disposed on different lighting axes and a difference image of the images;

FIGS. 4A through 4C illustrate examples of using the line-of-sight-based authentication apparatus according to an exemplary embodiment of the present invention;

FIG. 5 is a flowchart illustrating a line-of-sight-based authentication method according to an exemplary embodiment of the present invention;

FIG. 6 is a flowchart illustrating a line-of-sight-based authentication method according to another exemplary embodiment of the present invention; and

FIG. 7 illustrates the structure of a human eye.

### DETAILED DESCRIPTION OF THE EXEMPLARY EMBODIMENTS OF THE PRESENT INVENTION

The present invention will now be described more fully with reference to the accompanying drawings, in which exemplary embodiments of the present invention are shown. The present invention may, however, be embodied in many different forms and should not be construed as being limited to the exemplary embodiments set forth herein; rather, these exemplary embodiments are provided so that this disclosure will be thorough and complete, and will fully convey the concept of the present invention to those skilled in the art.

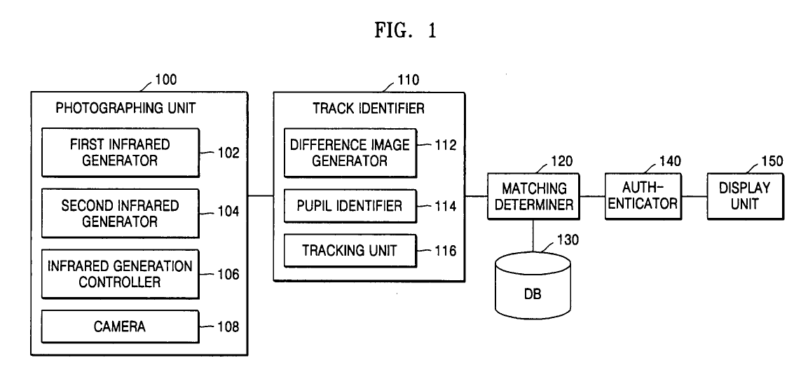

FIG. 1 is a block diagram of a line-of-sight-based authentication apparatus according to an exemplary embodiment of the present invention. Referring to FIG. 1, the line-of-sight-based authentication apparatus includes a photographing unit 100, a track identifier 110, a matching determiner 120, a database 130, an authenticator 140, and a display unit 150.

The photographing unit 100 includes a first infrared generator 102, a second infrared generator 104, an infrared generation controller 106, and a camera 108 to photograph the eyes of a user when the eyes are within a predetermined photographing range.

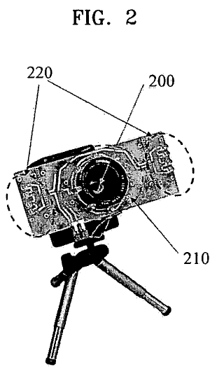

The first infrared generator 102 is disposed on the same axis as a photographing axis of the camera 108 and generates a first infrared ray used as lighting of the camera 108. The second infrared generator 104 is disposed on an axis different from the photographing axis of the camera 108 and generates a second infrared ray used as the lighting of the camera 108. Placement of the camera 108, the first infrared generator 102, and the second infrared generator 104 will be described in more detail with reference to FIG. 2.

The infrared generation controller 106 controls the first infrared generator 102 and the second infrared generator 104 to generate the first and second infrared rays, respectively, in turn. For example, when photographing the eyes of a person using an analog camera, if an odd-field image on a screen is generated, the infrared generation controller 106 controls the first infrared generator 102 to generate the first infrared ray as the lighting of the camera 108. If an even-field image is generated, the infrared generation controller 106 controls the second infrared generator 104 to generate the second infrared ray. When photographing the eyes of a person using a digital camera with a charge coupled device (CCD), the infrared generation controller 106 controls the first infrared generator 102 and the second infrared generator 104 to take turns generating the first and second infrared rays, respectively, in synchronization with a cycle of a shutter of the camera.

If the eyes of the person are within a predetermined photographing range, the camera 108 takes a photograph of the eyes using a digital camera with a CCD or an analog camera. The camera 108 uses sequentially the first and second infrared rays as lighting, which are generated by the first infrared generator 102 and the second infrared generator 104, respectively. The photographing range of the camera 108 may be set to less than 1 meter. A distance sensor (proximity sensor) that uses, for example, ultrasonic waves, infrared rays, or lasers to determine whether a subject has entered into the photographing range, may be used.

The camera 108 photographs the eyes of the person using the first infrared ray as lighting and generates a first image. Additionally, the camera 108 photographs the eyes of the person using the second infrared ray as lighting and generates a second image. The pupils of the eyes in the first image generated using the first infrared ray as lighting look bright due to the first infrared ray that passes through the pupils and is reflected by the retinas of the eyes. However, the pupils of the eyes in the second image generated using the second infrared ray look dark due to the second infrared ray that does not pass through the pupils and is not reflected by the retinas but is instead reflected by the corneas of the eyes.

The track identifier 110 identifies a track of eye movements based on the first and second images generated by the photographing unit 100. Specifically, the track identifier 110 includes a difference image generator 112, a pupil identifier 114, and a tracking unit 116.

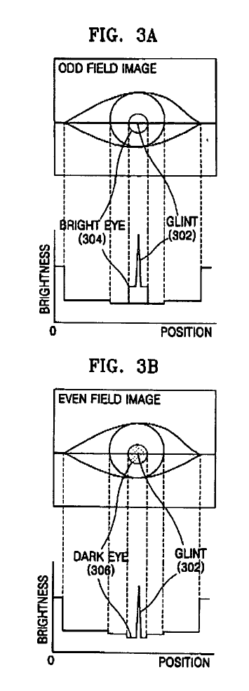

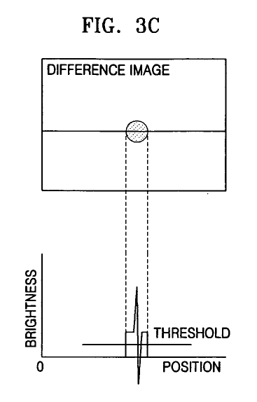

The difference image generator 112 generates a difference image based on a difference between the first image and the second image. As described above, the brightness of the pupils in an image varies according to whether an infrared ray used as the lighting of the camera 108 is on the same axis as the photographing axis of the camera 108. Therefore, if there is a difference between the first and second images, a background having an equal level brightness is removed and only an image with the pupils having different levels of brightness can be obtained. The difference image will be described in more detail with reference to FIGS. 3A through 3C.

The pupil identifier 114 identifies the brightly shining pupils in the difference image generated by the difference image generator 112 using an image processing technology, for example, an edge detection method. The image processing technology that can be used, however, includes diverse methods of extracting a predetermined region from an image other than the edge detection method. In an exemplary embodiment of the present invention, the difference image is used to enhance the accuracy of an edge detection method.

The tracking unit 116 traces a track of the eye movements (i.e., a line of sight) identified from the difference image. Starting and ending points of the track can be identified based on the blinks of the eyes or the passage of a predetermined period of time. If the eyes are in the photographing range of the photographing unit 100 and do not move for a predetermined period of time, the tracking unit 116 recognizes a current position of the eyes as the starting point of the track. The image processing technology for tracking the movements of an object in a predetermined region identified in an image will not be described in detail since such image processing technology is well-known.

For example, if a user enters into the photographing range of the photographing unit 100 and looks at the camera 108 for a predetermined period of time without moving his or her eyes, the track identifier 110 recognizes the current position of the eyes as the starting point for tracking the eye movements and identifies a track of the eye movements by tracking the eye movements for a predetermined period of time.

Alternatively, if the user blinks after looking at the camera 108, the track identifier 110 recognizes a first blink of the eyes as the starting point for tracking the eye movements, and if the user blinks again, the track identifier 110 regards a second blink of the eyes as the ending point of the tracking. The track identifier 110 may also identify the starting or ending point of the tracking if the user activates a predetermined mechanism, for example, a switch.

The matching determiner 120 determines whether the track identified by the track identifier 10 matches a track for authentication purposes previously stored in the database 130. For example, if the track for authentication purposes stored in the database 130 has a pattern of “upper left ->upper right->lower left->lower right->upper left,” the matching determiner 120 determines whether the track of the eye movements (i.e., the line-of-sight) identified by the track identifier 110 also has the pattern of “upper left ->upper right->lower left->lower right->upper left.”

The authenticator 140 determines that authentication is successful if a degree of matching determined by the matching determiner 120 exceeds a predetermined threshold. The authenticator 140 determines that the authentication is unsuccessful if the degree of matching does not exceed the predetermined threshold.

The display unit 150 displays the starting and ending points of the tracking of the eye movements (i.e., the starting and ending points of inputting a password), and the success or failure of the authentication is output aurally (e.g., by a speaker) or visually (e.g., by an LED).

FIG. 2 illustrates locations of the camera 200 and infrared generators according to an exemplary embodiment of the present invention. Referring to FIG. 2, the photographing unit 100 includes the camera 200, a first infrared generator 210, and a second infrared generator 220. The first infrared generator 210 includes a plurality of lamps generating infrared rays and disposed around the lens of the camera 200 to be on the same axis as the photographing axis of the camera 200. The second infrared generator 220 includes a plurality of lamps generating infrared rays and disposed a predetermined distance away from the lens of the camera 200 on both sides of the photographing unit 100 to be on an axis different from the photographing axis of the camera 200.

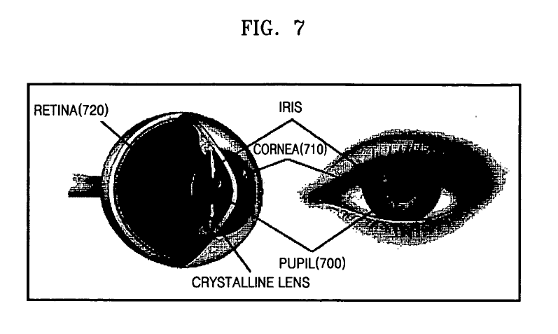

FIGS. 3A through 3C illustrate images of the eye taken using infrared rays disposed on different lighting axes and a difference image of the images. FIG. 7 illustrates the structure of the eye. FIGS. 3A through 3C will now be described with reference to FIG. 7.

FIG. 3A illustrates an image of the eye taken using the first infrared ray generated by the first infrared generator 102 or 210 disposed on the same axis as the photographing axis of the camera 108 or 200 and a brightness spectrum of the image. The first infrared ray generated by the first infrared generator 102 or 210 not only is reflected by a cornea 710 but also passes through a pupil 700 and is reflected by a retina 720. Therefore, the brightness spectrum of the image of the eye using the first infrared ray shows a glint 302 caused by the reflection of the first infrared ray by the cornea 710 and a bright eye 304 caused by the pupil 700.

FIG. 3B illustrates an image of the eye taken using the second infrared ray generated by the second infrared generator 104 or 220 disposed on an axis different from the photographing axis of the camera 108 or 200 and a brightness spectrum of the image. Since the second infrared generator 104 or 220 is disposed on the different axis from the photographing axis of the camera 108 or 200, the second infrared ray is reflected by the cornea 710 but does not pass through the pupil 700 to be reflected by the retina 720. Therefore, the brightness spectrum of the eye taken using the second infrared ray shows the glint 302 caused by the reflection of the second infrared ray by the cornea 710 and a dark eye 306.

The images illustrated in FIGS. 3A and 3B are generated in turn. For example, in the case of an analog image, even-field and odd-field images are generated. Thus, an even-field image is taken using the first infrared ray, and an odd-field image is taken using the second infrared ray.

FIG. 3C illustrates a difference image obtained based on the difference between the image of FIG. 3A and the image of FIG. 3B. As described above, the images of FIGS. 3A and 3B are different in terms of the bright eye 304 but not in terms of other parts of their brightness spectrums. If there is a difference between the images of FIG. 3A and FIG. 3B, the difference image with the pupil 700 having different levels of brightness can be obtained. From such a difference image, the pupil 700 can be easily detected using, for example, an edge detection method. In other words, it is possible to identify a portion of the difference image that exceeds a predetermined threshold (i.e., the pupil 700) and a track of the eye movements by tracking the movements of the portion.

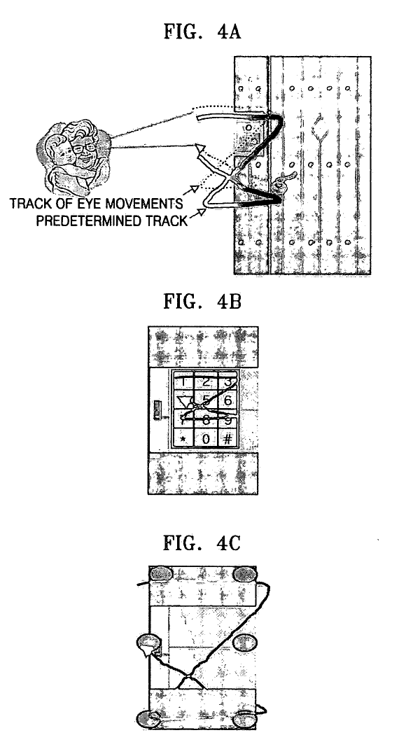

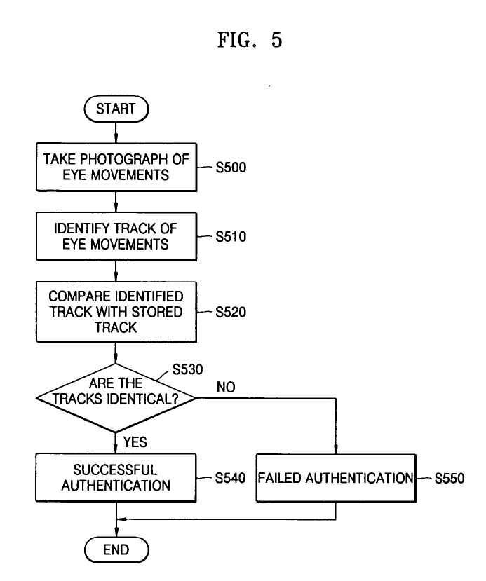

FIGS. 4A through 4C illustrate examples of using the line-of-sight-based authentication apparatus according to an exemplary embodiment of the present invention. Referring to FIG. 4A, when the line-of-sight-based authentication apparatus is used in a door, a user moves his eyes in a predetermined track while looking at a camera (not shown) installed in the door. Then, the line-of-sight-based authentication apparatus determines if a track identified by the movements of the eyes is the same as a track previously stored for authentication purposes. If the two tracks are identical, the line-of-sight-based authentication apparatus opens the door.

Referring to FIGS. 4B and 4C, a number plate or a predetermined mark is attached to an external surface of the line-of-sight-based authentication apparatus to help a user memorize a track easily and move his or her eyes more clearly. Therefore, the user can move his or her eyes according to a predetermined sequence of numbers on the number plate or the predetermined mark. The line-of-sight-based authentication apparatus may also be used as a locking device, for example, in a mobile phone or a personal digital assistant (PDA), or as an authenticator included in an ATM.

FIG. 5 is a flowchart illustrating a line-of-sight-based authentication method according to an exemplary embodiment of the present invention. Referring to FIGS. 1 and 5, if a user enters into a photographing range of the camera 108, the photographing unit 100 photographs the eyes of the user using the first infrared ray generated on the same axis as the photographing axis and generates the first image. In addition, the photographing unit 100 photographs the eyes using the second infrared ray generated on a different axis from the photographing axis and generates the second image (S500).

The track identifier 110 obtains a difference image based on a difference between the first image and the second image and, from the difference image, identifies the pupil that has a level of brightness exceeding a predetermined threshold by the bright eye 304 (S510). The tracking unit 116 tracks the movements of the pupil (S510).

The matching determiner 120 determines if a track previously stored for authentication purposes is the same as a track identified by the track identifier 110 (S520 and S530). If the two tracks are identical to a level exceeding a predetermined threshold, the authenticator 140 determines that the authentication is successful. If the two tracks are not identical to a level exceeding the predetermined threshold, the authenticator 140 determines that the authentication has failed (S550).

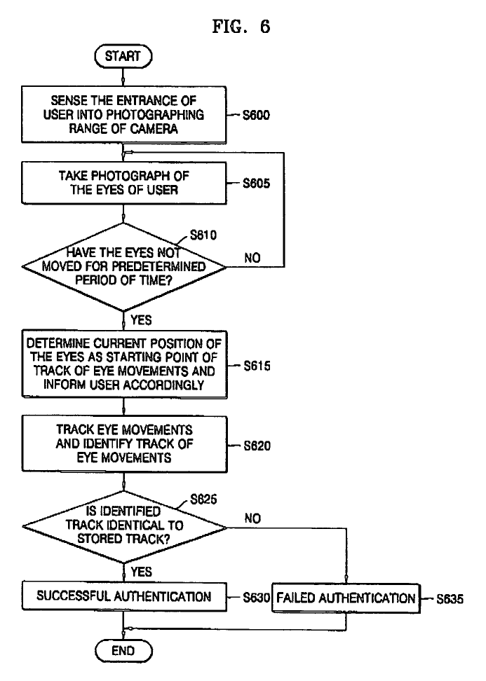

FIG. 6 is a flowchart illustrating a line-of-sight-based authentication method according to another exemplary embodiment of the present invention. Referring to FIGS. 1 and 6, if a user enters into a photographing range of the camera 108, the photographing unit 100 starts a photographing operation (S600). Whether the user has entered into the photographing range can be determined, for example, by a proximity sensor using ultrasonic waves, infrared rays, or lasers. The photographing unit 100 identifies the eyes of the user from an image taken using the first infrared ray generated on the same axis as the photographing axis and the second infrared ray generated on the axis different from the photographing axis (S605).

If the eyes do not move for a predetermined period of time (S610), a current position of the eyes is regarded as a starting point for the tracking of eye movements. The user is informed when the starting point for the tracking is detected, for example, through sound or light (S615). The track identifier 110 tracks the eye movements of the user and identifies a track of the eye movements (S620).

After a predetermined period of time, the matching determiner 120 determines if a track previously stored for authentication purposes is the same as the track identified by the track identifier 110 to a level exceeding a predetermined threshold (S625). If the two tracks are identical to a level exceeding the predetermined threshold, the authenticator 140 determines that the authentication is successful (S630). If the two tracks are not identical to a level exceeding the predetermined threshold, the authenticator 140 determines that the authentication has failed (S635).

The present invention uses a track of eye movements as a code for authentication. Thus, a fraudulent use of the code can be prevented. Additionally, the present invention is very convenient since it operates in a non-contact manner. Moreover, there are various patterns of track that can be used as codes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A line-of-sight-based authentication apparatus comprising:
a photographing unit which generates a first image by photographing an eye of a person using first lighting generated on a first axis that is the same as a photographing axis of a camera and generates a second image by photographing the eye of the person using second lighting generated on a second axis different from the photographing axis of the camera;
a track identifier which tracks movement of the eye based on the first image and the second image and identifies a first track of the movement; and
a matching determiner which determines if the first track is the same as a previously stored second track within a predetermined threshold.

2. The apparatus of claim 1, wherein the photographing unit comprises:
a first infrared generator, disposed on the first axis, which generates a first infrared ray as the first lighting;
a second infrared generator, disposed on the second axis, which generates a second infrared ray as the second lighting;
an infrared generation controller which controls the first infrared generator and the second infrared generator to generate the first infrared ray and the second infrared ray in turn; and
the camera which photographs the eye using the first infrared ray and the second infrared ray and generates the first image and the second image.

3. The apparatus of claim 2, wherein the first infrared generator comprises a plurality of first lamps which generate the first infrared ray and are disposed around a lens of the camera to be on the first axis, and
wherein the second infrared generator comprises a plurality of second lamps which generate the second infrared ray and are disposed a predetermined distance away from the lens of the camera to be on the second axis.

4. The apparatus of claim 1, wherein the track identifier comprises:
a difference image generator which generates a difference image based on the first image and the second image;
a pupil identifier which identifies the pupil of the eye in the difference image; and
a tracking unit which tracks the movement of the eye.

5. The apparatus of claim 1, wherein the track identifier recognizes a current position of the eye as a starting point of the first track if the eye is within a photographing range of the photographing unit and does not move for a predetermined period of time.

6. The apparatus of claim 1, wherein the track identifier recognizes a starting point and an ending point for the first track based on blinks of the eye.

7. The apparatus of claim 1, wherein the track identifier recognizes a starting point and an ending point for the first track based on passage of a predetermined period of time.

8. The apparatus of claim 1, wherein the track identifier recognizes a starting point and an ending point for the first track based on input through an external switch.

9. The apparatus of claim 1, further comprising an authenticator which determines that authentication of the person is successful if the matching determiner determines that the first track is the same as the second track within the predetermined threshold.

10. The apparatus of claim 6, further comprising a display unit which displays at least one of the starting point and the ending point of the first track.

11. The apparatus of claim 9, further comprising a display unit which displays information on whether the authentication of the person is successful, said information being displayed at least one of aurally and visually.

12. A line-of-sight-based authentication method comprising:
generating a first image by photographing an eye of a person using first lighting generated on a first axis that is the same as a photographing axis of a camera and generating a second image by photographing the eye using second lighting generated on a second axis different from the photographing axis of the camera;
tracking movement of the eye based on the first image and the second image and identifying a first track of the movement; and
determining if the first track is the same as a previously stored second track within a predetermined threshold.

13. The method of claim 12, wherein the generation of the first image and the second image comprises:
controlling a first infrared generator and a second infrared generator to sequentially generate a first infrared ray generated on the first axis and a second infrared ray generated on the second axis;
photographing the eye using the first infrared ray as the first lighting and generating the first image; and
photographing the eye using the second infrared ray as the second lighting and generating the second image.

14. The method of claim 12, wherein the tracking the movement of the eye and the identifying the first track comprises:
generating a difference image based on the first image and the second image;
identifying the pupil of the eye in the difference image; and
tracking the movement of the eye based on movement of the pupil.

15. The method of claim 12, wherein the tracking the movement of the eye and the identifying the first track comprises recognizing a current position of the eye as a starting point of the first track if the eye is within a photographing range of the camera and does not move for a predetermined period of time.

16. The method of claim 12, wherein the tracking the movement of the eye and the identifying the first track comprises recognizing a starting point and an ending point of the first track based on blinks of the eye.

17. The method of claim 12, wherein the tracking the movement of the eye and the identifying the first track comprises recognizing a starting point and an ending point of the first track based on passage of a predetermined period of time.

18. The method of claim 12, wherein the tracking the movement of the eye and the identifying the first track comprises recognizing a starting point and an ending point of the first track based on inputs from the person through an external switch.

19. The method of claim 12, further comprising determining that authentication of the person is successful if the first track is the same as the second track within the predetermined threshold.

20. The method of claim 12, further comprising displaying at least one of the starting point and the ending point of the first track.

21. The method of claim 19, further comprising displaying information on whether the authentication of the person is successful, said information being displayed at least one of aurally and visually.
